(19) United States
(12) Patent Application Publication
(10) Pub. No.: US 2020/0331730 A1
(43) Pub. Date: Oct. 22, 2020

(54) CONTROL SYSTEM AND METHOD FOR CONTROLLING A CRANE ASSEMBLY OF A WORK VEHICLE

(71) Applicant: Deere & Company, Moline, IL (US)

(72) Inventors: Mikko Palmroth, Tampere (FI); Marko T. Paakkunainen, Tampere (FI)

(21) Appl. No.: 16/851,339

(22) Filed: Apr. 17, 2020

(30) Foreign Application Priority Data
Apr. 18, 2019 (EP) 19170268.7

(51) Int. Cl. B66C 13/48; B66C 13/46

(52) U.S. Cl. CPC B66C 13/48; B66C 1/585; B66C 13/46

(57) ABSTRACT

A control system configured to control movement of a hydraulically operated crane assembly and a crane tool of a work vehicle with a primary power source and a hydraulic working system. The control system configured to calculate a deviation between an actual value and a predetermined target value of a lifting movement of the crane assembly, and configured to control the crane assembly to fulfill the predetermined target value.

### FIELD OF THE DISCLOSURE

This disclosure relates to a control system for controlling a crane assembly and a crane tool of a work vehicle. The disclosure further relates to a method for controlling a crane assembly and a crane tool. The disclosure further relates to a working machine having a crane assembly.

### BACKGROUND OF THE DISCLOSURE

Work machines may comprise an articulated hydraulic crane assembly which further may have a tool attached to a boom tip of the crane. The tool may be a gripping tool, an excavating tool, or in case of forestry related working machines, a harvesting or processing head, or a log grapple. Such crane assemblies and tools may handle heavy loads, which may comprise of soil or logs or different raw materials. Often such crane assemblies are controlled by hydraulic actuators that are driven by hydraulic power from one or more hydraulic pumps. The pumps are usually powered by the primary power source of the work vehicle.

When the crane assembly is used to lift a load, the primary power source provides the lifting capacity or lifting torque via the hydraulic circuit, the pumps, and the hydraulic actuators. Every load on the crane assembly has a lever arm which results in a lifting torque applied to the crane assembly. In case a load is handled that requires more lifting torque than currently available, or is exceeding the lift capacity, the crane assembly will provide only limited, slow or no movement capability. When the actual lifting torque exceeds the available lifting torque of the crane assembly, loading operation cannot proceed. Therefore, the crane operation requires preplanning of the load and the movements of the crane assembly.

### SUMMARY OF THE DISCLOSURE

In one embodiment, a control system configured to control movement of a hydraulically operated crane assembly and a crane tool of a work vehicle with a primary power source and a hydraulic working system is disclosed. The control system is configured to calculate a deviation between an actual value and a predetermined target value of a lifting movement of the crane assembly, and configured to control the crane assembly to fulfill the predetermined target value. The control system comprises sensors, which are configured to measure actual values of an actuating speed and/or an actuating hydraulic pressure and/or positioning data of the crane assembly, a control unit, having a CPU, configured to receive the measured actual values, calculate the deviation between the actual value and predetermined target value of the lifting movement of the crane assembly and calculating corrective measures of the crane assembly to minimize deviation, the corrective measures being either of increasing power output of the primary power source, increasing a power output of the hydraulic power source, movement of the crane assembly and/or movement of the crane tool, so that a required lifting torque is reduced and the predetermined target value is fulfilled.

The control system enables calm and fluid work operation of the vehicle and its operator. The crane assembly is adjusted to the handle a workload without interference by the operator. Critical situations of the crane not reacting or even failing may be avoided and work safety may be increased as well as fatigue of the operator may be reduced.

The sensors may be configured to be attached on the crane assembly of a work vehicle, wherein the sensors supply measured data to the control unit.

The sensors can be easily maintained and have direct signal lines to the control system and the related components.

The predetermined target value may be configured to be derived from an operator station of a work vehicle, depending on a lever actuation by the operator according to actuating speed, actuating angle or actuating a button.

The operator's input is used to adjust the crane. This enables a direct control scheme of the crane and reduces unnecessary data collection to control the crane.

The disclosure further describes a method of controlling a hydraulically operated crane assembly and a crane tool of a work vehicle with a primary power source and a hydraulic working system, comprising measuring an actual value of an actuating hydraulic pressure and/or an actuating speed and/or a position of the crane assembly, calculating a predetermined target value derived from the operator station of the work vehicle, calculating a deviation of a lifting movement of the crane assembly between the predetermined target value and the actual value, calculating corrective measures to minimize the deviation, and controlling the crane assembly to execute the corrective measures and reduce a required lifting torque.

The control method enables calm and fluid work operation of the vehicle and its operator. The crane assembly is adjusted to the handle a workload without interference by the operator. Critical situations of the crane not reacting or even failing may be avoided and work safety may be increased as well as fatigue of the operator may be reduced.

The corrective measures may control a power output of the primary power source and/or control the power output of the hydraulic power source and/or control movement of the crane assembly.

The parameters enable an effective control of the crane without any intermediate computing steps.

The controlled movement may actuate the crane assembly to move a tip of the crane assembly closer to the base of the crane assembly. This reduces required lifting torque and the lever arm of the crane.

The controlled movement may actuate a boom extension inward to bring a tip of the crane assembly closer to the base of the crane assembly.

The controlled movement may actuate the crane assembly so that the tip of the crane assembly is moving closer to the base of the crane assembly without further lifting the tip of the crane assembly upwards.

The disclosure further describes a work vehicle comprising a primary power source, a hydraulic power source and a hydraulic working system, a crane assembly, having at least a first and a second boom section, rotatably attached to each other, a boom extension, slidably attached to the second boom section, a boom tip, attached to the boom extension, a slewing apparatus, attached between the work vehicle and the crane assembly, sensors, at least on the crane assembly and the operator station, for measuring a position and/or hydraulic pressure and/or actuating speed of the crane assembly, and a control system.

The vehicle enables calm and fluid work operation of the vehicle and its operator. The crane assembly is adjusted to the handle a workload without interference by the operator. Critical situations of the crane not reacting or even failing may be avoided and work safety may be increased as well as fatigue of the operator may be reduced.

A crane tool may be attached to the crane assembly and controlled by the hydraulic working system.

Other features and aspects will become apparent by consideration of the detailed description and accompanying drawings.

### BRIEF DESCRIPTION OF THE DRAWINGS

FIG. 1 shows a forestry vehicle being a harvester.

FIG. 2 shows a forestry vehicle being a forwarder.

FIG. 3 shows a control scheme of the crane assembly.

Before any embodiments are explained in detail, it is to be understood that the disclosure is not limited in its application to the details of construction and the arrangement of components set forth in the following description or illustrated in the following drawings. The disclosure is capable of other embodiments and of being practiced or of being carried out in various ways. Further embodiments of the disclosure may include any combination of features from one or more dependent claims, and such features may be incorporated, collectively or separately, into any independent claim.

As used herein, unless otherwise limited or modified, lists with elements that are separated by conjunctive terms (e.g., “and”) and that are also preceded by the phrase “at least one of” or “one or more of” indicate configurations or arrangements that potentially include individual elements of the list, or any combination thereof. For example, “at least one of A, B, and C” or “one or more of A, B, and C” indicates the possibilities of only A, only B, only C, or any combination of two or more of A, B, and C (e.g., A and B; B and C; A and C; or A, B, and C).

### DETAILED DESCRIPTION

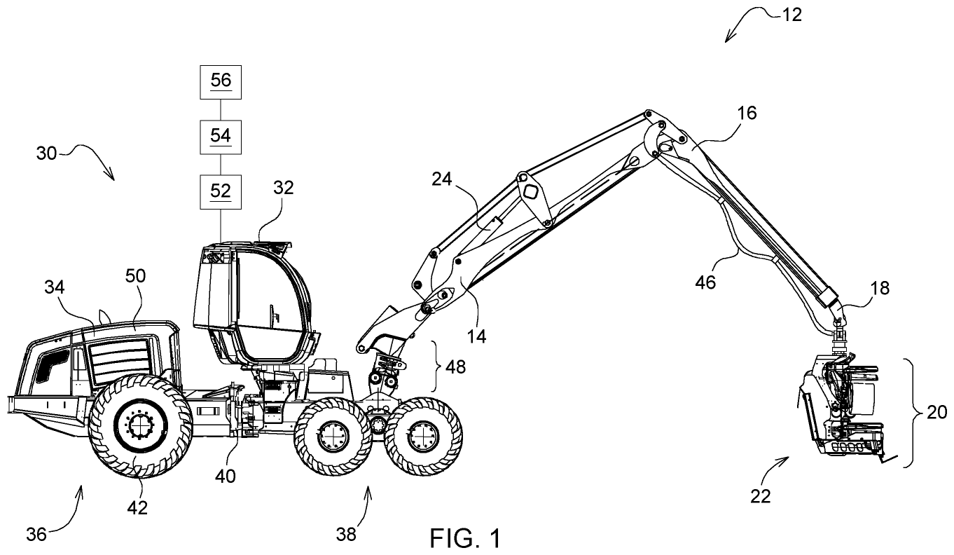

FIG. 1 discloses a harvester 30. The harvester 30 has a front chassis 38 and a rear chassis 36 which are movably connected by a joint 40 and further comprise driven wheels 42 connected to the front and rear chassis 38, 36. By controlling the angle between the front and rear chassis 38, 36, the harvester 30 can be steered by an operator. The harvester 30 further comprises an engine 34 attached to the rear chassis 36. The engine 34 may be arranged on different areas of the harvester 30. The engine 34 acts as the primary power source of the harvester 30 and also drives a main hydraulic pump 50 to power a hydraulic system of the harvester 30. The engine 34 can also power additional secondary hydraulic systems which are used to actuate smaller hydraulic actuators in the harvester 30, such as climbing ladders or steps or actuate the operator station 32.

The harvester 30 has an operator station 32 on the front chassis 38, usually comprising an operator cabin with a seat arrangement for the operator and control surfaces to control the harvester 30. The control surfaces can comprise a steering wheel, controls for actuating and moving the crane assembly 12 and attached tools 22. The operator cabin can be movably attached to the front chassis 38, so that the operator cabin can be rotated and/or tilted. In front of the operator station 32 in FIG. 1, the crane assembly 12 is movably attached to the front chassis 38. The crane assembly 12 is usually attached by a slewing apparatus 48 which enables tilting and rotating of the complete crane assembly 12 around the harvester 30 to increase the reach of the crane assembly 12 assembly.

The crane assembly 12 comprises at least a first boom section 14 and a second boom section 16, movably linked to each other and actuated by hydraulic actuators 24. The crane assembly 12 may further comprise a boom extension 18, which is slidably connected to the second boom section 16 and allows a linear extension of the crane assembly 12 further increasing the reach of the crane assembly 12. A boom tip section 20 is movably connected to the boom extension 18 and can comprise a crane tool 22. The boom tip section 20 can also comprise a rotator, which allows actuated rotation of the crane tool 22 around a vertical axis. The crane tool 22 and the rotator are usually supplied by and connected to the hydraulic system by a hydraulic line 46, being provided along or inside of the crane assembly 12 components.

The operator may steer the harvester 30 to the intended felling area and use the crane assembly 12 to attach the crane tool 22, usually a felling head, to a stem of a tree. The operator uses the control surfaces provided to control the crane assembly 12 and the crane tool 22 and starts the felling procedure, whereas the tree falls over and is held by the crane tool 22. Then the crane tool 22 is used to cut the stem into sized pieces and cuts of any branches in the process. It might be necessary for the operator to move the crane assembly 12 with the attached fallen tree before cutting due to process needs such as available space in the area, steepness of the terrain or length of the tree. The actuation of the crane assembly 12 requires a supply of hydraulic power which depends on the overall reach of the crane assembly 12 and the weight of the tree in the crane tool 22.

The harvester 30 comprises a control system 52 which is connected to and comprises the crane assembly 12 and sensors 54 which measure various parameters of the crane assembly 12 such as the actuating speed of the crane assembly 12, actuating hydraulic pressure in the hydraulic actuators 46 to move the crane assembly 12 and positioning data of the components of the crane assembly 12, such as the first and second boom section 14, 16, the boom extension 18 and the boom tip section 20. The sensor data is provided to a CPU 56. The CPU 56 calculates a possible deviation between the current supplied data and the input of the operators control surfaces, such as the control lever movement and the control lever actuating speed. A control lever input, such as a lifting command by the operator is transferred into an upward movement of the crane assembly 12. Hydraulic power is supplied to the actuator 46 so that a lifting force of the crane assembly 12 is enabled. In ordinary working conditions this will result in an upward lifting movement of the crane assembly 12.

In case the tree in the crane tool 22 is heavy, or the reach of the crane assembly 12 is at an upper end, the torque on the crane assembly 12 is increased so that a lifting movement of the crane assembly 12 will not be ensured. Sensors 54 detect an increase in hydraulic pressure but will also detect non-movement and no positional change of the crane assembly 12. The CPU 56 compares these values with the input lever movement and angle calculating a deviation of crane assembly 12 behavior. The CPU 56 is then used to select between various corrective measurements to return the crane assembly 12 operation back to normal working conditions. The CPU 56 can cause the primary power source or engine 34 to increase power output to increase hydraulic power available to the crane assembly 12 and the hydraulic actuators 46. CPU 56 may also control the hydraulic actuators 46 of the crane assembly 12 not to continue a lifting movement but to first actuate the crane assembly 12 to bring the boom tip section 20 closer to the base of the crane assembly 12 in order to reduce the lift arm and lifting torque. This may result in a horizontal movement of the boom tip section 22 without an upward movement. CPU 56 may control all other hydraulic component that are of secondary importance to pause in order to further redirect hydraulic power to the actuators of crane assembly 12. By control system 52, the crane assembly 12 is thus able to execute the lifting movement as intended by the operator.

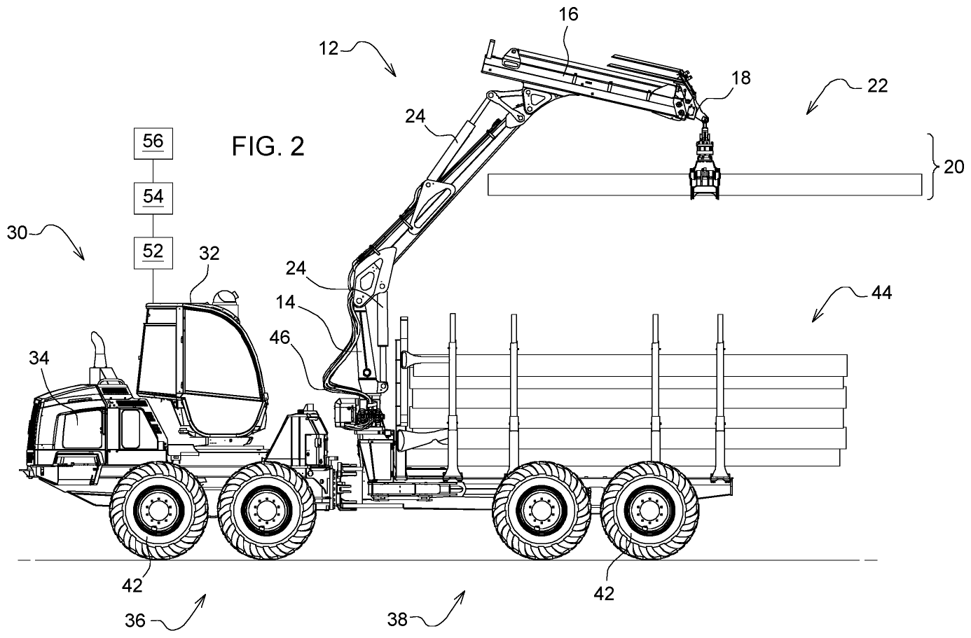

FIG. 2 shows a forwarder used to transport logs out of the felling area. Like the harvester 30 of FIG. 1, the forwarder has a front and rear chassis. Both chassis are movably connected to each other and are actuated hydraulically to enable steering of the forwarder. The front chassis 38 carries the operator station 32 and the primary power source or engine 34 and the hydraulic power source 50. The operator cabin can be rotatable, so that the operator can have a forward seated position during drive operation and a bunk facing or rearward seated position during loading operation.

The operator uses the crane assembly 12 to load logs from the ground to the bunk space 44. The crane assembly 12 can have a first and second boom section 14 and 16, as well as an intermediate boom section between the first and second boom sections 14, 16. The crane assembly 12 is controlled by hydraulic actuators 46 mounted between the boom sections. The second boom section 16 may have a boom extension 18, which allows linear extension of the crane reach. At an end of the boom extension a boom tip section 20 may be movably attached, together with a crane tool, usually a grapple to load logs.

The crane assembly 12 can be used to load single or multiple logs at the same time. This operation uses the crane assembly 12 with different loads, leading to different actuating torque of the crane assembly 12. The crane assembly 12 of the forwarder is used in different conditions, such as step areas, different seasons and different temperatures and different space conditions.

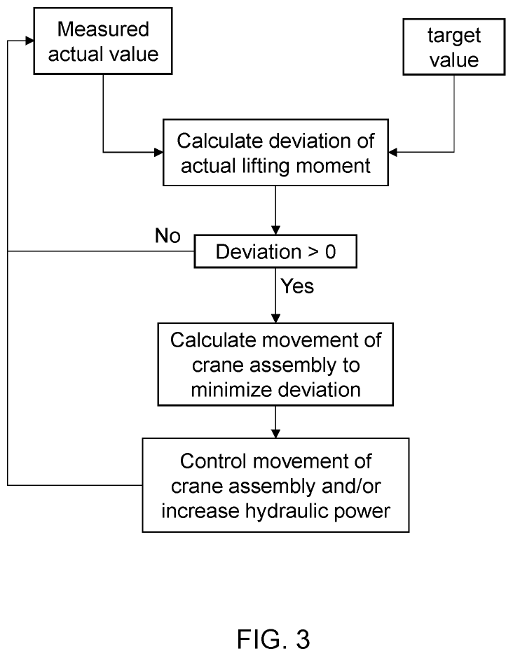

FIG. 3 shows a control scheme of the control system 52. Sensors 54 provide measured data from the crane assembly 12 and its current stated. In parallel the input from the operator station control surfaces are used to set a target value for the crane assembly 12, such as speed, position or hydraulic pressure. CPU 56 calculates a deviation of the measured values by calculating a target value from the operator input and evaluates the deviation. In case a deviation is detected, control system 52 calculates a corrective measure to return crane operation parameter within the target value. The calculation is then executed by either a movement of crane assembly 12 or an increase of hydraulic power.

In a first example, the CPU 56 compares a target value for actuating speed of crane assembly 12. This target value is set by the operators input on the related control surfaces. Usually the operator uses control levers to manipulate the crane assembly 12. The lever adjusting speed from the operator's movement can be calculated in actuating speed of the related crane functions. If the operators speed is fast or if the movement of the levers is large this can be regarded as a requirement for a fast movement of the crane assembly 12 by the control system 52. Sensors 54 on crane assembly 12 collect the reaction movement of crane assembly 12 by either angle measurement or by length measurement. The feedback is then compared by the control system 52 via CPU 56. If the control system 52 calculates a deviation of the actual movement to a target movement value, the control system 52 detects that the necessary torque for moving crane assembly 12 is not sufficient.

One solution by the control system 52 can be to stop movement of the crane assembly 12 as intended by the operator and to initiate a relief movement of crane assembly 12, such as to reduce a necessary torque requirement. The control system 52 may control crane assembly 12 to just move the boom tip section 20 closer to the base of the crane assembly 12. This reduces required lifting torque. When a certain movement of the boom tip section 20 has been detected, the control system 52 may switch back to the instructed movement by the operator which can be fulfilled with the required speed.

Another solution of the control system 52 can be to increase hydraulic power supply. The control system 52 instructs the related hydraulic pump to increase its flow rate so that the necessary hydraulic force is available for actuating the crane assembly 12. Control system 52 may also at the same time instruct the primary power source of the harvester 30 to increase power output to drive the related hydraulic pump.

In another example, the control system 52 may detect a deviation of the position of the crane assembly 12 in comparison to a target position. The sensors 54 can detect current positions of the various segments of crane assembly 12. CPU 56 compares these values with intended position values related to the operators input.

In yet another example, the control system 52 can stop movement of the crane assembly 12 as intended by the operator and to initiate a relief movement of crane assembly 12, such as to reduce a necessary torque requirement. The control system 52 may control crane assembly 12 to just move the boom tip section 20 closer to the base of the crane assembly 12. This reduces required lifting torque. When a certain movement of the boom tip section 20 has been detected, the control system 52 may switch back to the instructed movement by the operator which can be fulfilled with the required speed.

In another example, the control system 52 can increase hydraulic power supply. The control system 52 may instruct the related hydraulic pump to increase its flow rate so that the necessary hydraulic force is available for actuating the crane assembly 12. Control system 52 may also at the same time instruct the primary power source of the harvester 30 to increase power output to drive the related hydraulic pump.

In yet another example, the control system 52 may detect a deviation of the hydraulic pressure. Sensors 54 can detect hydraulic pressure inside the actuators 24 of crane assembly 12. The target value can be calculated from the input of the operator and the resulting manouvers of crane assembly 12.

In another example, the control system 52 may stop movement of the crane assembly 12 as intended by the operator and to initiate a relief movement of crane assembly 12, such as to reduce a necessary torque requirement. The control system 52 may control crane assembly 12 to just move the boom tip section 20 closer to the base of the crane assembly 12. This reduces required lifting torque. When a certain movement of the boom tip section 20 has been detected, the control system 52 may switch back to the instructed movement by the operator which can be fulfilled with the required speed.

In yet another example, the control system 52 may increase hydraulic power supply. The control system 52 instructs the related hydraulic pump to increase its flow rate so that the necessary hydraulic force is available for actuating the crane assembly 12. Control system 52 may also at the same time instruct the primary power source of the harvester 30 to increase power output to drive the related hydraulic pump.

In case the control system 52 detects no deviation between the measured values and the target values, the control system 52 will not initiate any corrective measures and return to further comparing target values and current values.

The control system 52 enables the operation of the harvester 30 without any interference due to slow responsiveness of crane assembly 12 during operation. The operator is relieved of permanent surveillance of the weight of the lifted cargo. This results in less fatigue and smoother work load and increased work speed.

What is claimed is:

1. A control system configured to control movement of a hydraulically operated crane assembly and a crane tool of a work vehicle with a primary power source and a hydraulic power source, the control system comprising:
a sensor configured to measure actual values of at least one of an actuating speed, an actuating hydraulic pressure, or positioning data of the crane assembly; and
a control unit having a CPU configured to receive the measured actual values, calculate the deviation between the actual value and a predetermined target value of the lifting movement of the crane assembly, and calculate corrective measures of the crane assembly to minimize the deviation;
wherein, the corrective measures comprise at least one of increasing a power output of the primary power source, increasing a power output of the hydraulic power source, movement of the crane assembly, or movement of the crane tool so that a required lifting torque is reduced and the predetermined target value is fulfilled.

2. The control system of claim 1, wherein the sensor is coupled to the crane assembly of the work vehicle.

3. The control system of claim 1, wherein the predetermined target value is determined by an actuating speed or actuating angle of a lever or a button actuation.

4. A method for controlling a hydraulically operated crane assembly and a crane tool of a work vehicle with a primary power source and a hydraulic power source, the method comprising:
measuring an actual value of at least one of an actuating hydraulic pressure, an actuating speed, or a position of the crane assembly;
calculating a predetermined target value derived from an operator station of the work vehicle;
calculating a deviation of a lifting movement of the crane assembly between the predetermined target value and the actual value;
calculating a corrective measure to minimize the deviation; and
controlling the crane assembly to execute the corrective measure and reduce a required lifting torque.

5. The method of claim 4, wherein the corrective measure is at least one of controlling a power output of the primary power source, controlling the power output of the hydraulic power source, or controlling movement of the crane assembly.

6. The method of claim 5, wherein the controlling movement is actuating the crane assembly to move a tip of the crane assembly closer to a base of the crane assembly.

7. The method according to claim 5, wherein the controlling movement is actuating a boom extension inward to bring a tip of the crane assembly closer to a base of the crane assembly.

8. The method according to claim 5, wherein the controlling movement is actuating the crane assembly so that a tip of the crane assembly is moving closer to a base of the crane assembly without further lifting the tip of the crane assembly upward.

9. A work vehicle comprising:
a primary power source;
a hydraulic power source and a hydraulic working system;
a crane assembly, having at least a first and a second boom section, rotatably coupled to each other;
a boom extension, slidably coupled to the second boom section;
a boom tip, coupled to the boom extension;
a slewing apparatus, coupled between the work vehicle and the crane assembly; and
a control system comprising:
a sensor configured to measure actual values of at least one of an actuating speed, an actuating hydraulic pressure, or positioning data of the crane assembly; and
a control unit having a CPU configured to receive the measured actual values, calculate the deviation between the actual value and a predetermined target value of the lifting movement of the crane assembly, and calculate corrective measures of the crane assembly to minimize the deviation;
wherein, the corrective measures comprise at least one of increasing a power output of the primary power source, increasing a power output of the hydraulic power source, movement of the crane assembly, or movement of the crane tool so that a required lifting torque is reduced and the predetermined target value is fulfilled.

10. The work vehicle of claim 9, further comprising a crane tool coupled to the crane assembly and controlled by the hydraulic working system.
